(19) United States
(12) Patent Application Publication
(10) Pub. No.: US 2009/0231143 A1
(43) Pub. Date: Sep. 17, 2009

(54) DEVICE AND METHOD TO CONTROLLING AND DATA ACQUISITION SYSTEM VIA COMMUNICATION NETWORK

(76) Inventor: Ravindra WIJESIRIWARDANA, Bentonville, AR (US)

Correspondence Address: RAVINDRA WIJESIRIWARDANA, 2001 LATROBE DRIVE APT 20, BENTONVILLE, AR, 72712, US

(21) Appl. No.: 12/401,796

(22) Filed: Mar. 11, 2009

Related U.S. Application Data
(60) Provisional application No. 61/036,758, filed on Mar. 14, 2008.

(51) Int. Cl. G08B 23/00; G05B 23/02; H04W 4/12

(52) U.S. Cl. 340/573.1; 340/3.1; 455/466

(57) ABSTRACT

The present invention discusses controlling physiological information monitoring device or environmental monitoring device or location monitoring device mobile telephone or data network. In addition this system is capable of sending the information to the controller or the user by converting the information into multimedia massages (MMS) such as graphics voice and video. In this way the information can be send to the user in high fidelity, high reliability, better power efficiency, and economically in pseudo real time.

### CROSS-REFERENCE TO RELATED APPLICATIONS

This application claims the benefit of provisional patent application Ser. No. 61/036,758, filed Mar. 14, 2008 by the present inventor.

### FEDERALLY SPONSORED RESEARCH

Not Applicable

### SEQUENCE LISTING OR PROGRAM

Not Applicable

### BACKGROUND

1. Field

This application relates to controlling and transmitting, physiological, environmental and location information via mobile communication devices.

2. Prior Art

Controlling devices through communication network/s are used in many applications. Many protocols and standards have been used. The control and information signals are converted into analog or digital signals and transmitted via public switching telephone networks (PSTN) or public switching data networks (PSDN).

Continuous physiological and environmental information transmission via PSTN and PSDN networks are being used in many applications. However, most of the physiological information signal transmission is limited to electro cardiogram signals (ECG). In addition the environmental information transmission is limited to Location data such as global positioning systems (GPS) data. U.S. Pat. No. 6,400,956 discusses a system that sends the location information via PSTN or DSTN networks. In this method the system is initiated by the communication device having the location identification unit. Further this information is transmitted and displayed by the means of discreet text or in real time.

However due to the signal band width limitations and terrain limitations it becomes very difficult to transmit these information reliably in real time. In case of transmitting physiological information such as ECG, a very high fidelity of the ECG is required to do any diagnostics. Due to the poor signal quality of the PSTN or PSDN networks it is impossible to transmit high fidelity ECG signals in real time under most demanding conditions. This limitation also applies to the other physiological information signals such as electro encephalogram (EEG), electro myogram (EMG), pulse plethysmography (PPG), blood gasses concentrations, blood glucose concentrations, respiration and body temperature transmission in real time.

First part of the invention discusses real-time continuous transmission of physiological signals such as PPG, EEG, EMG, pulse plethysmography (PPG), blood gases concentrations, blood glucose concentrations, respiration and body temperature of a mammal via PSTN or PSDN networks. The second part of the invention discusses transmission of this physiological information as recorded multimedia messages via PSTN or PSDN. In addition one aspect of this invention is controlling physiological information monitoring unit, or an environmental information monitoring unit, or a location information monitoring unit by using a remote unit as the controller and PSTN or PSDN as the medium in between the controller and the monitoring unit.

The primary system consists of a controller “A”, communication device “B”, communication network PSTN or PSDN “C”, another communication device “D” and a sensors signal acquisition system “E” (FIG. 1A).

This system is capable of controlling a remotely connected sensors signal acquisition system “E” via the controller “A” and acquiring and displaying data from the remotely connected sensors signal acquisition system “E”.

The sensors signal acquisition system “E” is one or many combinations of physiological information monitoring unit or environmental information monitoring unit or location information monitoring unit. The above systems may be wearable systems integrated or attached to garments of the wearer. The measured and monitored sensors parameters of these devices are in the 3^{rd} column of the FIG. 2A.

The communications devices “B” and “D” can be any communication device such as home phone, a personal digital assistant (PDA), a computer or a mobile phone device that has a modem connecting to PSTN or PSDN or connect to a PSTN or PSDN via any other means. The controller “A” may be embedded together with the communication device or connected to the communication device via wireless or cable connection. Controller “A” is capable of controlling and retrieving data from acquisition system “E”. The control signals and protocol include, powering the device: (ON,OFF), setting up the configuration parameters of the devices “E”, setting up the data format and request for Data asynchronously or synchronously. The communication device “D” is responsible for acknowledging to the controller “A”.

The signaling processes and controlling commands may be sent out to “E” as dual tone multiple frequency DTMF signals or text based short messages (SMS) or multimedia messages (MMS) or voice messages via GSM, GPRS, EDGE, UMTS networks (PSTN or DSTN).

The data acquisition system may be embedded with a phone modem or attached to the phone modem by using cable or wireless communication systems such as Bluetooth. In case of using a Bluetooth device connected to a mobile phone unit operating under GSM, the audio gateway of the Bluetooth protocol can be used to transmit the sensor parameters to the communication device “B” in real time.

### DRAWING—FIGURES

FIG. 1A—The block diagram of the controlling and data acquisition system.

FIG. 1B—The block diagram of the system with Bluetooth device.

FIG. 1C—The block diagram of the algorithm that describes the converting and sending environmental, location or physiological information as MMS.

FIG. 1D—The block diagram of the algorithm that describes the controller “A” data reception side.

FIG. 1E—The block diagram of the algorithm that describes the data sending side.

FIG. 2A—The table of the sensors signal acquisition system “E” devices and their corresponding measured and monitored parameters.

FIG. 3A—Show the ECG signal transmitted in real time via PSTN or PSDN.

FIG. 3B—shows the ECG signal converted into a picture file first and transmitted by using MMS via PSTN PSDN.

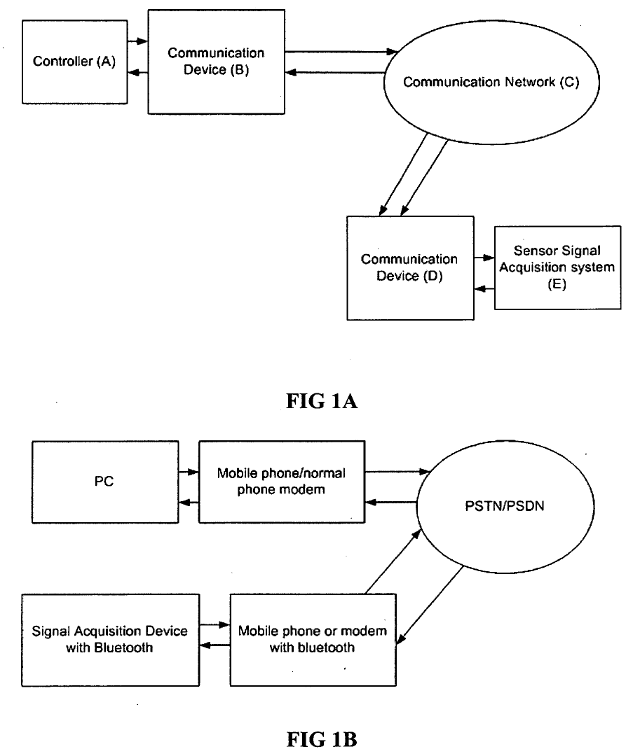

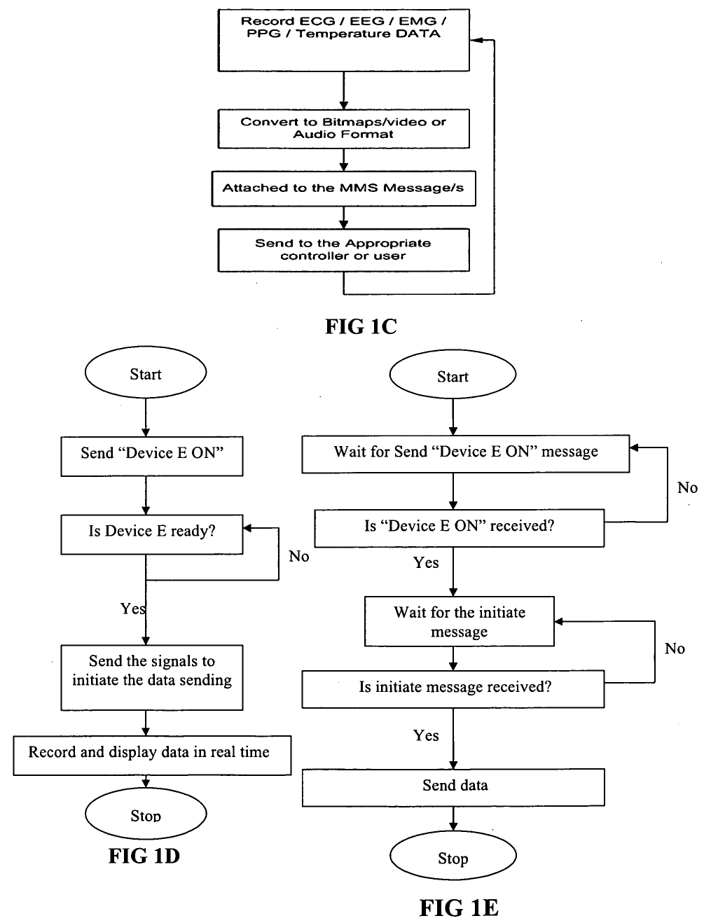

### DETAILED DESCRIPTION OF FIG. 1A AND FIG. 1B

FIG. 1A shows the block diagram of the controlling and data acquisition system. The system consists of a controller “A”, communication device “B”, communication network “C”, another communication device “D” and a sensors signal acquisition system “E”. The controller “A” connected to the communication device “B”. The communication device “B” is connected to the communication network “C” either PSTN or DSTN. The sensors signal acquisition system “E” is connected to the communication device “D”.

FIG. 1B shows the block diagram of the system with Bluetooth device for connecting the communication device “D” and sensors signal acquisition system “E”.

### Operation of the System

The operation of the system can be described in two parts. The first part is controlling of a physiological information monitoring unit or environmental information monitoring unit or location information monitoring unit via the PSTN or DSTN network and their data transmission in real time. The second part is the converting the physiological information or environmental information or location information into multimedia messages (MMS) and transmitted via the PSTN or DSTN.

Controller “A” may be a software device in a mobile phone (the communication device B). “A” sends the “Unit ON” message by using SMS, MMS, voice, DTMF or as a character based messages to the device “E” on to the other communication device “D”. Upon receiving this message, the device “E” turns itself on and sends the message “device E ready” to the controller “A” via SMS, MMS, voice, DTMF or as character based messages. Upon receiving this message the controller “A” asks for the data and the device “E” acknowledges to the controller “A” by sending the data. Termination of the communication between the two devices can be done by either party. FIG. 1D shows the Controller “A” side algorithm used for data reception and FIG. 1E shows the algorithm used for the data sending by the device “E”.

In addition since most of the frequency band widths of physiological signals and environmental parameter signals are operating between 0 Hz to 300 Hz, these signals need to be modulated in order to transmit through a PSTN network since it has a frequency bandwidth of 300 Hz 3.8 KHz. In this present invention these signals are first modulated by using amplitude modulation or frequency modulation or phase modulation with a carrier frequency in the transmission bandwidth of the PSTN or DSTN. Then the received signal at the receiving end is being demodulated before displayed or recorded. By using this method these signals can be transmitted at a very high signal to noise ratio in data or voice communication frequency band. The data signals may be physiological information such as ECG, PPG, EEG, EMG, pulse plethysmography (PPG), blood gases concentrations, blood glucose concentrations, respiration and body temperature or environmental information such as atmospheric temperature, atmospheric humidity, atmospheric pressure, composition of atmospheric air and radiation (UV, Gamma) or location information such as latitude, longitude, speed, direction and height from the sea level.

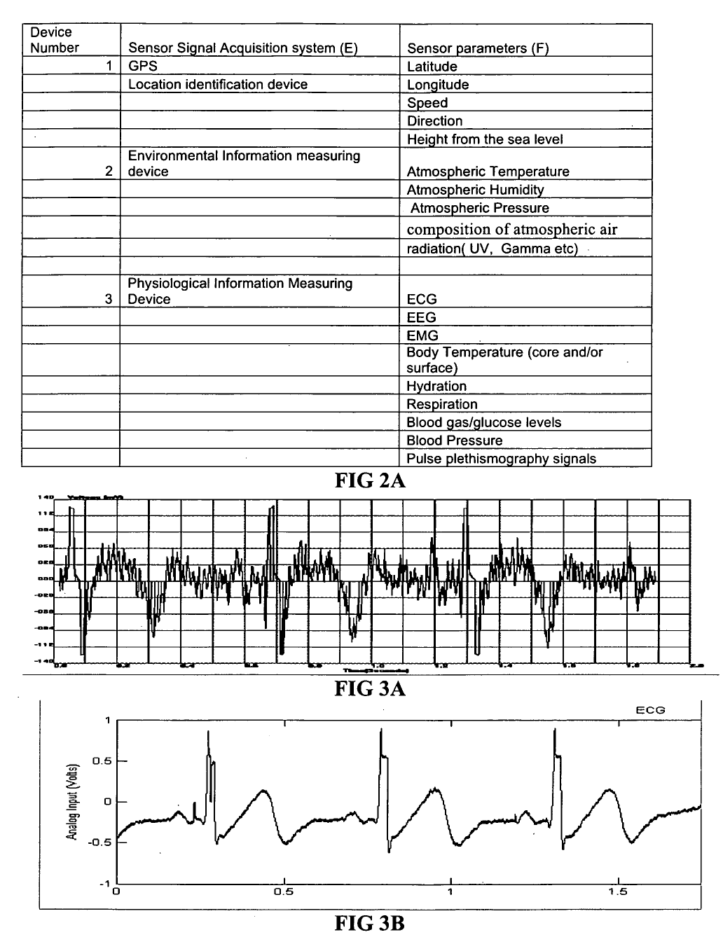

In the second part of this invention the multimedia messaging services (MMS) provided by the mobile communication networks today are used for the transmission of the physiological information ECG,PPG, EEG, EMG, pulse plethysmography (PPG), blood gases concentrations, blood glucose concentrations, respiration and body temperature or environmental information such as atmospheric temperature, atmospheric humidity, atmospheric pressure, composition of atmospheric air and radiation (UV, Gamma) or location information such as latitude, longitude, speed, direction and height from the sea level. These corresponding signals are first recorded and convert to bitmap (graphics), audio or video formats and send then send them as a multimedia messaging (MMS) used in mobile networks. This way more high quality data can be transmitted and information can be acquired graphically by the controller and display in pseudo real time. The data is converted into a multimedia data file such as graphics, audio or video and attached to a text message (MMS) and sent to the controller upon initiation of the data flow. Such information has very high quality since the signal can be stored as a picture. Similarly environmental parameters stated above are transmitted by using the same system. The algorithm in FIG. 1C shows the operation of the software in the phone or the signal acquisition system “E”. This method is very much economical for the physicians since they can get the data anywhere by using the MMS messages available today with the mobile communication devices. In addition this method is not band width heavy and hence has the ability to send information with high fidelity so that the remote diagnostics can be done. Moreover at the same time very highly reliable as well. A ECG signal transmitted via PSTN or PSDN in real time is shown in FIG. 3A and same ECG signal transmitted after converting into a picture file and sent via MMS of a PSTN or PSDN is shown in FIG. 3B. It is clear from this data that better quality data can be transmitted by converting the information into a multimedia message and sending by using MMS of PSTN or PSDN.

I claim

1. A system capable of controlling a remote sensors signals acquisition systems via a mobile telephone network or mobile data network comprises of;
(a) A controller connected to the communication network in one end that initiates the remote sensors signals acquisition systems in the other end of the communication network to power on, initialized, send the data and power down.
(b) A mobile communication network that connects the controller to the remote sensors signals acquisition systems.
(c) A remote sensors signals acquisition systems that acknowledge to the controlling signals from the controller.

2. A system according to claim 1 where the remote sensors signals acquisition system is an environmental information monitoring system or physiological monitoring system or location information monitoring system.

3. A device according to claim 1 or claim 2 where the transmitted information that is the physiological information or environmental information or location information first converted into the a multimedia messages such as graphical photos or video or audio files and send them via multimedia messaging services of the mobile network.

4. A system according to claim 2 where the location information monitoring system a global position system (GPS) or a compass.

5. The information transmitted to the controller by a system according to claim 4 be latitude, longitude, direction, speed, height from the sea level and the location on the road map.

6. The information transmitted to the controller by a physiological information monitoring system according to claim 2 or claim 3 is ECG, PPG, EEG, EMG, pulse plethysmography (PPG), blood gases concentrations, blood glucose concentrations, respiration and body temperature.

7. The information transmitted to the controller by an environmental information monitoring system according to claim 2 or claim 3 is atmospheric temperature, atmospheric humidity, atmospheric pressure, composition of atmospheric air and radiation levels.

8. A system according to claim 1 or claim 2 or claim 3 where the controlling is done via dual tone multiple frequency DTMF signals or text based short messages (SMS) or multimedia messages (MMS) or voice messages via GSM, GPRS, EDGE, UMTS networks.

9. A system according to claim 1 or claim 2 or claim 3 where the information is modulated to suite the communication medium via a modulation scheme such as amplitude modulation (AM) or frequency modulation (FM) or phase modulation (PM).

10. A system according to claim 1 or claim 2 or claim 3 where time division multiplexing (TDM, frequency division multiplexing (FDM), any combination or derivatives of these two schemes are used or the transmission of the data and information in real time.

11. Use of a system according to claim 1 or claim 2 or claim 3 for monitoring a vehicle, a boat ship, plain, any mammal, any animal.

12. A system according to claim 1, claim 2 or claim 3 having multiple physiological information units or location detection units or environmental sensing units that can be controlled and connected to a single controller so that mutable monitoring can be done by the same system.
